(19) United States
(12) Patent Application Publication
(10) Pub. No.: US 2014/0062635 A1
(43) Pub. Date: Mar. 6, 2014

(54) MAGNETIC CORE FOR MAGNETIC COMPONENT WITH WINDING, CONTAINING IMPROVED MEANS OF COOLING

(71) Applicant: GE Energy Power Conversion Technology Ltd, Warwickshire (GB)

(72) Inventors: Jerome Delanoe, Belfort (FR); Eric Guette, Belfort (FR)

(73) Assignee: GE Energy Power Conversion Technology Ltd, Warwickshire (GB)

(21) Appl. No.: 14/012,470

(22) Filed: Aug. 28, 2013

(30) Foreign Application Priority Data
Aug. 31, 2012 (FR) 1258161

(51) Int. Cl. H01F 27/10

(52) U.S. Cl. CPC H01F 27/10
USPC 336/61

(57) ABSTRACT

A magnetic core extends in a longitudinal direction and contains at least one stacking of sheets consisting of magnetic material and stacked in a direction of stacking perpendicular to the longitudinal direction, at least one plate of heat-conducting material, presenting first and second opposing faces, and at least one cooling tube positioned in contact with the said first face of the plate in which a heat-bearing fluid is designed to circulate. The plate extends in a plane parallel to the longitudinal direction and to the direction of stacking, its second face being positioned in thermal contact with the sheets in the stacking.

### BACKGROUND OF THE INVENTION

Embodiments of the present invention relate to a magnetic core for a magnetic component with winding, such as an induction coil or transformer, containing improved means of cooling.

There thus exist magnetic components, especially induction coils, which contain a winding that surrounds such a magnetic core.

Usually, a magnetic component with winding is assessed according to three criteria, namely: good efficiency (limited losses), reduced size and reduced cost.

These three criteria are not, generally speaking, compatible. In particular, a magnetic component with optimised efficiency is generally of larger size and more costly than a magnetic component sized to offer reduced cost. This means that one of the three above-mentioned criteria is usually optimized to the detriment of at least one of the two others. It is observed that the current trend in the state of the art involves giving priority to cost and size criteria to the detriment of the efficiency criterion.

It will be noted that efficiency in a magnetic component is linked to losses of energy within this magnetic component. These losses consist principally of losses within the windings (known as “joule losses”) and losses within the magnetic core (known as “iron losses”).

The joule losses generally account for more than 80% of the total losses from the magnetic component. It is known to the specialist in the field that optimal output is achieved when the iron losses in the core are substantially equal to the joule losses within the winding.

In order to achieve a balance between joule losses and iron losses, provision is made in EP 1 993 111 for cooling a magnetic core by means of a system of cold plates. In particular, this cooling helps increase the capacity of the core to evacuate its losses, and therefore helps increase induction levels in the core.

The removal of heat by such a system is not however always satisfactory. In particular, the present inventors have observed that, in EP 1 993 111, the cooling is carried out at the same time as lamination, which limits the heat flow passing from the core to the cold plates.

### BRIEF DESCRIPTION OF THE INVENTION

Embodiments of the present invention remedy the above mentioned problems by supplying a magnetic core with optimised cooling.

According to an embodiment of the present invention, there is provided a magnetic core for a magnetic component with winding, extending in a longitudinal direction. The magnetic core comprises at least one sheet stacking in magnetic materials, stacked in a stacking direction perpendicular to the longitudinal direction, at least one plate consisting of heat-conducting material, with its first and second faces opposite, and at least one cooling tube positioned in contact with the said first face of the plate, within which a heat-carrying fluid is designed to circulate, characterised in that the plate extends in a plane parallel to the longitudinal direction and the stacking direction, its second face being positioned in thermal contact with the stacking sheets.

According to an embodiment of the present invention, there is provided a magnetic component with winding. The magnetic component comprises a winding comprising a wire wound around a longitudinal axis, and a magnetic core extending in the longitudinal direction coaxially to the winding. The magnetic core comprises at least one stacking of sheets of a magnetic material, stacked in a stacking direction perpendicular to the longitudinal direction, at least one plate of a heat-conducting material, the at least one plate comprising a first face and a second face opposed to the first face, and at least one cooling tube in contact with the first face of the at least one plate, wherein a heat-bearing fluid circulates within the at least one cooling tube, wherein the at least one plate extends in a plane parallel to the longitudinal direction and to the stacking direction, and the second face is in thermal contact with the at least one stacking of sheets.

### BRIEF DESCRIPTION OF THE DRAWINGS

Embodiments of the present invention can be better understood from a reading of the description that follows, given purely as an example and made with reference to the attached figures, in which:

FIG. 1 is a sectional view of a three-phase induction coil according to an embodiment of the invention.

FIG. 2 is a sectional view, in the plane II of FIG. 1, of one of the coils and a portion of core surrounded by that coil according to an embodiment of the invention.

FIG. 3 is a view similar to FIG. 2 of a coil according to an embodiment of the invention.

FIG. 4 is a view similar to FIG. 2 of a coil according to an embodiment of the invention.

### DETAILED DESCRIPTION OF THE INVENTION

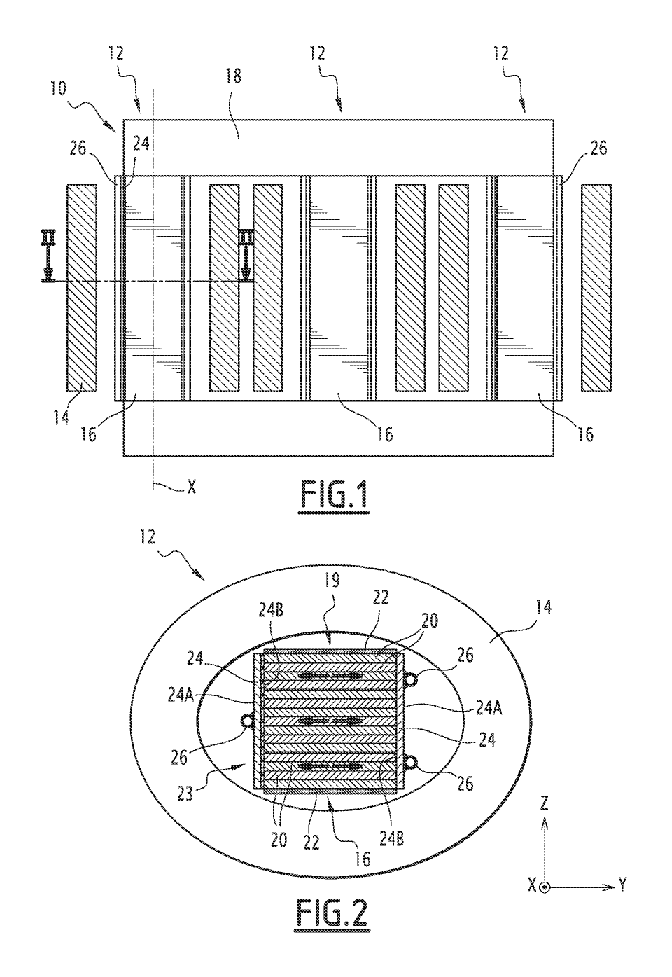

FIG. 1 is a representation of a three-phase set 10 containing three induction coils 12. The whole of the electrical circuit, including the connections, is of classic design and will not therefore be described in any more detail.

The three coils 12 are identical, and therefore only one of them will be described below.

Each induction coil 12 comprises a winding 14, consisting of a conductive element wound for example in a spiral shape around a longitudinal axis X. The conductive element is for example a wire, or produced using a hollow rolling or sheet.

Each coil 12 also comprises a magnetic core 16, extending in the direction of the longitudinal axis X, and as a result the winding 14 coaxially surrounds the magnetic core 16.

In standard formation, the three magnetic cores 16 are arranged in parallel and connected to a cylinder consisting of elements 18 for backflow from the magnetic core.

Each magnetic core 16 consists, in a known fashion, of a plurality of stackings 19 of sheets 20 of magnetic material, in an embodiment, iron. In the example described, the stackings 19 are classically separated by air gaps of an insulating, non-magnetic material. The stackings 19 are therefore placed one after another along the longitudinal axis X, with the air gaps perpendicular to this longitudinal axis X. In an embodiment, the magnetic core 16 may be free of such air gaps.

One of the stackings 19 is shown in section in FIG. 2.

The following defines a direction of stacking Z as being the direction in which the sheets 20 are stacked. This direction of stacking Z is perpendicular to the longitudinal direction X. In this way, each stacking 19 consists of individual sheets 20 extending in planes parallel to the longitudinal axis X.

In the example shown, the sheets 20 are of substantially identical dimensions, so that the stacking 19 is substantially parallelepipedal in form. In an embodiment, the sheets may be cut according to different patterns so that their arrangement has a section more similar to a circular section.

The sheets 20 may be connected together using any known method. For example, the stacking 19 of sheets 20 contains at least one traversing aperture (not represented) in the direction of stacking Z, with a tie extending into this aperture to ensure that the sheets 20 are connected with each other. In an embodiment, the core 16 contains two master sheets 22, pressed on either side of the sheets 20 in the direction of stacking Z to ensure that they are connected together by means of said tie. To this end, each tie bears on the master sheets 22 by means of its heads, for example in the form of nuts screwed onto the threaded ends of this tie.

In order to evacuate the heat in the magnetic core 16, this core comprises means of cooling 23, comprising in particular at least one plate 24 consisting of heat-conducting material. In the example shown in FIGS. 1 and 2, each magnetic core contains two plates 24 positioned on either side of the stacking 19 in a transverse direction Y perpendicular to the direction of stacking Z, as will be described below.

In this way, in contrast to a cooling device as per the state of the art, such as the one described in EP 1 993 111, the plates 24 do not provide mechanical holding of the sheets 20 with each other. The thickness of the plates 24 can therefore be substantially reduced, and the substance for these plates 24 can be chosen with technical and economic optimisation in mind, thus improving its heat conductivity and reducing its cost. It should be noted that EP 1 993 111 was designed to confer a double role of cooling and mechanical holding on the cooling plates. On the other hand, in accordance with the present invention, the cooling plates no longer fulfil the mechanical holding function, this function being fulfilled by the holding sheets 22, but on the other hand, they provide a much better level of cooling than in the state of the art.

Each sheet 24 has first 24A and second 24B opposing faces, each extending in a plane parallel to the longitudinal direction X and the direction of stacking Z.

The means of cooling 23 also contain, for each plate 24, at least one cooling tube 26, designed to stack up a heat-bearing fluid, positioned in contact with the first face 24A of the plate 24. The heat-bearing fluid may be any known type, for example water or oil.

In an embodiment, the cooling plates 24 and the tubes 26 consist of a highly heat-conductive and non-magnetic material, such as aluminium, copper or stainless steel.

The second face 24B of each plate 24 is positioned in thermal contact with the sheets 20 in the stacking 19, so that this stacking is interspersed between the plates 24. In this way, each plate 24 is positioned perpendicular to the sheets 20, in thermal contact with a section of each sheet 20. In other words, the cooling plates 24 are positioned perpendicular to the lamination of the stacking 19.

In the present description, the term “thermal contact” refers to a contact that allows transfer of heat by conduction between two elements. Such thermal contact may be either direct contact or contact through a thermally conductive layer.

In particular, a thermal paste, such as thermal grease, could be interspersed between at least one of the plates 24 and the sheets 20. Such thermal paste will help increase thermal conductivity between the plate 24 and the sheets 20, as the edges of these sheets 20 do not form a completely smooth surface together.

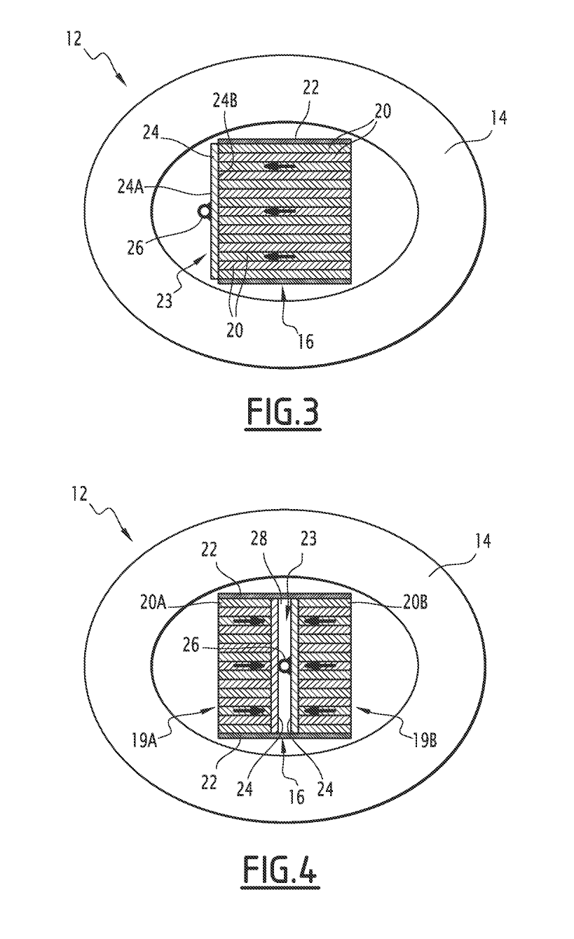

In addition, in accordance with this initial embodiment illustrated in FIG. 2, within which two cooling plates 24 are in contact with the sheets 20, it is necessary to isolate the magnetic sheets 20 electrically from at least one of these two cooling plates 24 in order not to create a loop of current within the magnetic circuit. This electrical isolation is not necessary when only one cooling plate 24 is in contact with the sheets 20, as is the case in the embodiments in of FIGS. 3 and 4, which will be described below, as no loop of current is created in this case.

In order to achieve this electrical isolation, at least one of the plates 20 contains, on its second face, a film of thermally conductive electrical insulation, so that the insulating film is interspersed between the second face 24B and the sheets 20. It will be noted that a low level of electrical isolation is generally sufficient, so that the electrically isolating film may consist of a single layer of varnish.

It will be noted that the cooling plates 24 may be held on the sheets 20 by any known means of fixing.

For example, in the stacking 19, an aperture passing in the transverse direction Y and a tie passing through that aperture could be provided to ensure that each plate 24 is secured against sheets 20 in the stacking 19.

In an embodiment, a strip may be provided wound around the stacking 19 and plates 24, in order to hold these plates 24 against the stacking 19.

FIG. 3 illustrates a coil 12 according to an embodiment of the invention. In this figure, the elements similar to the previous figures are indicated using identical references.

In accordance with the embodiment shown in FIG. 3, the means of cooling 23 contain only one cooling plate 24, in thermal contact with the sheets 20 on a surface perpendicular to the transverse direction Y. In fact, a single cooling plate 24 can be sufficient in some applications envisaged.

FIG. 4 illustrates a coil 12 according to an embodiment of the invention. In this FIG. 4, the elements similar to those in the previous figure are indicated using identical references.

In accordance with the embodiment shown in FIG. 4, the core 16 contains a first 19A and second 19B stacking of sheets 20A, 20B. The sheets 20A, 20B are stacked in the same direction of stacking Z and the stackings 19A, 19B extend in parallel to each other and to the longitudinal axis X. The first and second stackings 19A, 19B are separated from each other so as to produce a space 28.

The means of cooling 23 contain two plates 24 of heat-conducting material, arranged in the space 28 and each in thermal contact with the sheets 20A, 20B in a respective stacking 19A, 19B. The space 28 is therefore delimited by these two plates 24.

In addition, the means of cooling 23 contain at least one cooling tube 26 positioned between the plates 24, in contact with each of these plates 24. The cooling of the magnetic core 16 thus occurs at its heart.

In accordance with an embodiment shown in FIG. 4, the width of the magnetic sheets 20 transversely to the cold plate 24 is reduced (in particular, halved in relation to the width of the magnetic sheets in the embodiment shown on FIG. 3), which improves the cooling of these sheets, especially at the end of these sheets that is not in contact with the cold plate.

In addition, the embodiment as shown in FIG. 4 requires only a single cooling circuit, in contrast to the embodiment as shown in FIG. 1, which requires two.

It will be noted that the present invention is not limited to the embodiments described above, but could present various versions without extending outside the scope of the claims.

In particular, the magnetic core 16 could equip a transformer, such as a high-frequency transformer, or any other type of magnetic component with winding.

It will be noted that the means of cooling 23 described above could be used not only to remove significant losses in a magnetic component, but also to prevent any emission of heat in a given environment. For example, such emissions of heat are unwelcome in an undersea module.

In an embodiment, each cold plate is positioned perpendicular to the lamination of the sheets in the magnetic circuit. This arrangement allows optimal conduction of heat flows from the interior of the core to the heat-carrying fluid circuit. Embodiments of the present invention therefore allow optimal cooling of the magnetic core, which in turn allow considerable increases in induction.

In addition, optimised cooling helps reduce the dimensions of the core while retaining optimal induction. A reduction in the dimensions of the magnetic core also reduces the dimensions of the winding that surrounds the said core, and therefore reduces joule losses in the winding as well as the cost of the said winding.

An embodiment of the present invention helps increase iron losses (through improved cooling of the core) while reducing joule losses (through the reduced dimensions of the windings). In other words, an embodiment of the present invention helps achieve a balance between iron losses and joule losses, and therefore optimises efficiency as previously mentioned.

In addition, reducing the dimensions of the magnetic core and the winding also reduces the size of the magnetic component on one hand, and the quantity of material used to manufacture it on the other hand, and therefore the cost of the magnetic component.

This written description uses examples to disclose the present invention, including the best mode, and also to enable any person skilled in the art to practice the present invention, including making and using any computing system or systems and performing any incorporated methods. The patentable scope of the present invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A magnetic core for a magnetic component with winding, extending in a longitudinal direction, the magnetic core comprising:
at least one stacking of sheets of a magnetic material, stacked in a stacking direction perpendicular to the longitudinal direction;
at least one plate of a heat-conducting material, the at least one plate comprising a first face and a second face opposed to the first face; and
at least one cooling tube in contact with the first face of the at least one plate, wherein a heat-bearing fluid circulates within the at least one cooling tube, wherein the at least one plate extends in a plane parallel to the longitudinal direction and to the stacking direction, and the second face is in thermal contact with the at least one stacking of sheets.

2. The magnetic core as claimed in claim 1, wherein the at least one plate of a heat-conducting material further comprises two plates of heat-conductive material, wherein each of the two plates extends in a respective plane parallel to the longitudinal direction and to the stacking direction, and is positioned on either side of the at least one stacking in a transverse direction perpendicular to the longitudinal direction and the stacking direction.

3. The magnetic core as claimed in claim 2, wherein at least one of the two plates bears, on a respective second face, a film of thermally conductive electrical insulation, so that the film of insulation is interspersed between the respective second face and the sheets .

4. The magnetic core as claimed in claim 1, wherein the at least one plate bears, on the second face, a layer of thermal paste, such as a thermal grease, wherein the thermal paste is interspersed between the second face and the sheets.

5. The magnetic core as claimed in claim 1, wherein:
the at least one stacking of sheets comprises a first stacking of parallel sheets and a second stacking of parallel sheets, wherein the first stacking and the second stacking are separated from each other so as to form a space,
the first stacking bears, within said space, a first plate comprising heat-conducting material in contact with the sheets of the first stacking,
the second stacking bears, within said space , a second plate comprising heat-conducting material in contact with the sheets of the second stacking,
the first plate is positioned opposite to the second plate, and
the at least one cooling tube is positioned between the first plate and the second plate, in contact with each of the first plate and the second plate.

6. The magnetic core as claimed in claim 1, further comprising two master sheets, pressed on either side of the at least one stacking of sheets in the stacking direction to secure the sheets of the at least one stacking together.

7. The magnetic core as claimed in claim 1, wherein the at least one stacking of sheets comprises a plurality of stackings of sheets separated by air gaps of insulating material, the plurality of stackings being positioned one after another along the longitudinal direction, and the air gaps being perpendicular to the longitudinal axis.

8. The magnetic core as claimed in claim 1, wherein the at least one stacking of sheets comprises at least one aperture passing in a transverse direction perpendicular to the longitudinal direction and to the stacking direction of stacking, with a tie extending in the at least one aperture to secure each of the at least one plate against the sheets of the at least one stacking.

9. The magnetic core as claimed in claim 1, further comprising at least one strip rolled around the at least one stacking and each of the at least one plate to hold each of the at least one plate against the at least one stacking

10. A magnetic component with winding, the magnetic component comprising:
a winding comprising a wire wound around a longitudinal axis; and
a magnetic core extending in the longitudinal direction coaxially to the winding, wherein the magnetic core comprises:
at least one stacking of sheets of a magnetic material, stacked in a stacking direction perpendicular to the longitudinal direction;
at least one plate of a heat-conducting material, the at least one plate comprising a first face and a second face opposed to the first face; and
at least one cooling tube in contact with the first face of the at least one plate, wherein a heat-bearing fluid circulates within the at least one cooling tube,
wherein the at least one plate extends in a plane parallel to the longitudinal direction and to the stacking direction, and the second face is in thermal contact with the at least one stacking of sheets.

11. The magnetic component as claimed in claim 10, wherein the at least one plate of a heat-conducting material further comprises two plates of heat-conductive material, wherein each of the two plates extends in a respective plane parallel to the longitudinal direction and to the stacking direction, and is positioned on either side of the at least one stacking in a transverse direction perpendicular to the longitudinal direction and the stacking direction.

12. The magnetic component as claimed in claim 11, wherein at least one of the two plates bears, on a respective second face, a film of thermally conductive electrical insulation, so that the film of insulation is interspersed between the respective second face and the sheets .

13. The magnetic component as claimed in claim 10, wherein the at least one plate bears, on the second face, a layer of thermal paste, such as a thermal grease, wherein the thermal paste is interspersed between the second face and the sheets.

14. The magnetic component as claimed in claim 10, wherein:
the at least one stacking of sheets comprises a first stacking of parallel sheets and a second stacking of parallel sheets, wherein the first stacking and the second stacking are separated from each other so as to form a space,
the first stacking bears, within said space, a first plate comprising heat-conducting material in contact with the sheets of the first stacking,
the second stacking bears, within said space , a second plate comprising heat-conducting material in contact with the sheets of the second stacking,
the first plate is positioned opposite to the second plate, and
the at least one cooling tube is positioned between the first plate and the second plate, in contact with each of the first plate and the second plate.

15. The magnetic component as claimed in claim 10, wherein the magnetic core further comprises two master sheets, pressed on either side of the at least one stacking of sheets in the stacking direction to secure the sheets of the at least one stacking together.

16. The magnetic component as claimed in claim 10, wherein the at least one stacking of sheets comprises a plurality of stackings of sheets separated by air gaps of insulating material, the plurality of stackings being positioned one after another along the longitudinal direction, and the air gaps being perpendicular to the longitudinal axis.

17. The magnetic component as claimed in claim 10, wherein the at least one stacking of sheets comprises at least one aperture passing in a transverse direction perpendicular to the longitudinal direction and to the stacking direction of stacking, with a tie extending in the at least one aperture to secure each of the at least one plate against the sheets of the at least one stacking.

18. The magnetic component as claimed in claim 10, wherein the magnetic core further comprises at least one strip rolled around the at least one stacking and each of the at least one plate to hold each of the at least one plate against the at least one stacking
